(19) United States
(12) Patent Application Publication
(10) Pub. No.: US 2010/0122313 A1
(43) Pub. Date: May 13, 2010

(54) METHOD AND SYSTEM FOR RESTRICTING FILE ACCESS IN A COMPUTER SYSTEM

(75) Inventor: Rafel Rafi Ivgi, Modiin (IL)

Correspondence Address: FOLEY HOAG, LLP;PATENT GROUP, WORLD TRADE CENTER WEST, 155 SEAPORT BLVD, BOSTON, MA, 02110, US

(73) Assignee: Aspect9, Inc., New York, NY (US)

(21) Appl. No.: 12/267,600

(22) Filed: Nov. 9, 2008

(51) Int. Cl. G06F 21/00; H04L 9/32

(52) U.S. Cl. 726/1; 726/29

(57) ABSTRACT

A computer-implemented method is provided of controlling file access in a computer system. The method includes: (a) reading file association information; (b) building a security policy in accordance with the file association information comprising rules that restrict the access of applications to files based on file type, format, or extension; and (c) providing additional rules for the security policy not based on the file association information; (d) storing the security policy; and (e) controlling file access in accordance with the security policy.

### BACKGROUND

The present invention relates to generally to the field of computer security and, more particularly, to a method and system for restricting file access in a computer system.

In computer systems, access to files is typically filtered by operating systems per user. An application executed under a specified user credentials is allowed to access all the files to which the specified user has access. For example, if a given user “bob” has read, write, and execute access to a file, e.g., “c:\private.txt”, then applications such as an Internet browser also have read, write, and execute access to this file.

Security software can be used in an attempt to keep malicious software from accessing files and data and computer systems. For example, file access can be restricted using security software that is trained by the user and that asks the user to make decisions on whether to allow or deny file requests by processes. The amount of simultaneous file and data access (e.g., read and write) operations in an operating system in a single minute is very high. Therefore, asking a user to make a choice for every request can be very tedious and intrusive to users. Many security software solutions will remember the decision made for an access request as rule for matching requests in the future. This may increase the risk for information being compromised where a future request is initiated by malicious code, which should not be allowed. Some security software solutions allow an administrative user to manually specify a list of files and/or folders to actively access (e.g., read, write, move, rename, and delete). Some solutions will enforce this policy on the local computer or all computers on the network.

Security software solutions also exist that “take over” a network gateway while computers are booting and will check if those computers have an “Agent” installed to enforce the system configuration and security policies. Another approach used by security software solutions is to analyze the operating system installed with default or most common settings and applications, and make access rules for each software application (also known as “application white listing”). This requires mapping a large set of software applications and to maintain updates to the rules as software vendors may change their software behavior. There also exist “signature based” or “hash based” detection solutions such as Anti-Virus, Anti-Spyware, and Anti-Malware software, which detects specific files that are known to be malicious code or use heuristics (including behavioral analysis) to determine if a file is capable of doing harm or may contain malicious code. Some solutions focus on restricting data access to and from portable storage devices (e.g., USB removable drives, cameras, mobile phones, and media players) and some on external communication devices (e.g., WI-FI, WiMAX, Bluetooth, infra-red, network cards, and laptops) as the device being connected is mounted as a new drive/volume and the volume itself and the files inside it can be accessed as file objects. Some solutions use encryption of data to protect it from being accessed or manipulated by unauthorized applications.

There are additional software security solutions that analyze the data contained in files and create a unique signature, which allows them to later recognize the file or even partial data originated from that file, then taking action related to this information (e.g., deny access, report duplication or leakage to the administrator, and silently log activity).

Operating systems include a mechanism to determine which application will be executed when certain files are accessed. This mechanism will be referred herein as the “file association mechanism”. The information used by the mechanism will be referred to herein as the file association information. For example, a document file with the file extension of “.doc” under the Microsoft Windows operating system will be opened for reading or writing by default by an application called Microsoft Word that is stored as a file called winword.exe. The Microsoft Operating System will not open a file called “a.xxx” using the Microsoft Word application even if it is a document, because of the lack of the proper extension.

File association mechanisms are used by operating systems to execute the relevant applications but are not generally used for security purposes.

File association mechanisms can be very different from one operating system to another, and can rely on characteristics other than file extensions to determine a default operation for a certain file type.

### BRIEF SUMMARY OF EMBODIMENTS OF THE INVENTION

In accordance with one or more embodiments of the invention, a computer-implemented method is provided of controlling file access in a computer system. The method includes: (a) reading file association information; (b) building a security policy in accordance with the file association information comprising rules that restrict the access of applications to files based on file type, format, or extension; and (c) providing additional rules for the security policy not based on the file association information; (d) storing the security policy; and (e) controlling file access in accordance with said security policy.

In accordance with one or more embodiments of the invention, a computer program product is provided residing on a computer readable medium having a plurality of instructions stored thereon which, when executed by a processor, cause that processor to: (a) read file association information; (b) build a security policy in accordance with the file association information comprising rules that restrict the access of applications to files based on file type, format, or extension; (c) provide additional rules of the security policy not based on the file association information; (d) store the security policy; and (e) control file access in accordance with said security policy.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram illustrating an exemplary file access system in accordance with one or more embodiments of the invention.

FIG. 2 is a simplified block diagram illustrating components of exemplary restriction logic code in accordance with one or more embodiments of the invention.

FIG. 3 is a flow chart illustrating an exemplary process of restricting file access in a computer system in accordance with one or more embodiments of the invention.

### DETAILED DESCRIPTION

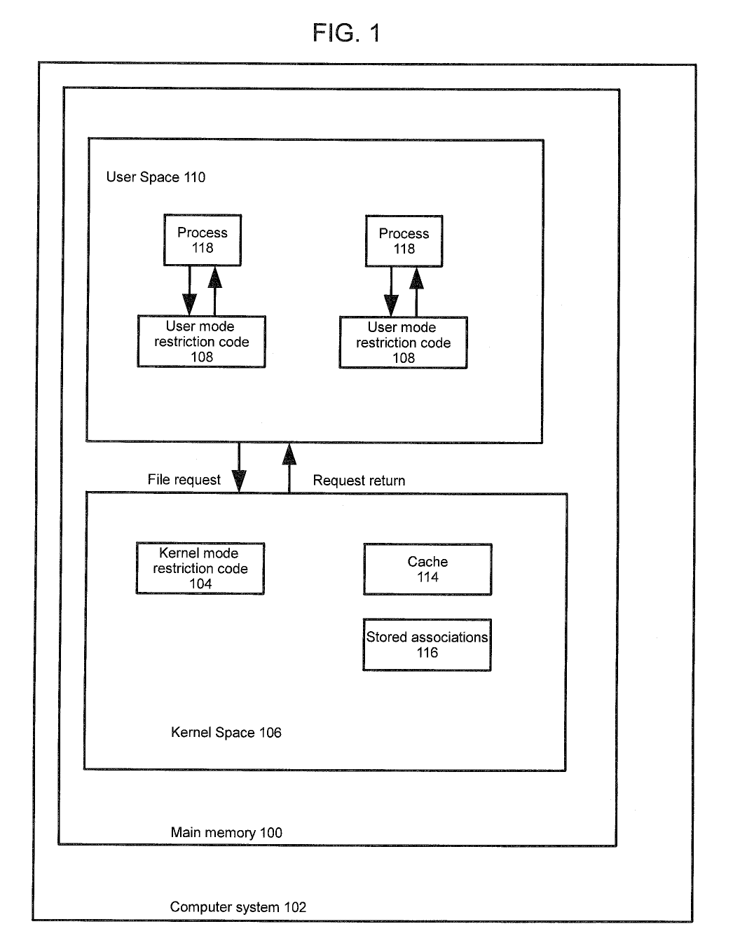

FIG. 1 is a simplified block diagram illustrating an exemplary file access system in accordance with one or more embodiments of the invention. The file access system is implemented in a computer system, e.g., a general-purpose or specific purpose computer. A representative computer includes, but is not limited to, a personal computer, workstation, server, smart phone, PDA, PocketPC, or “TabletPC” with any system platform that is, e.g., Intel Pentium, PowerPC or RISC based, and includes an operating system such as Windows, UNIX, Linux, MAC OS/X, or the like. As is well known, such machines include a processor, a storage medium readable by the processor, display interface (a graphical user interface or “GUI”) and associated input devices (e.g., a keyboard and mouse, or touchscreen).

The file access system is preferably implemented in software and can be loaded in the main memory 100 of the computer system 102 along with the operating system and application programs. For example, as shown in FIG. 1, in some embodiments, the file access system can be implemented as kernel mode restriction logic code 104 in the kernel space 106 of main memory 100. In some embodiments, the file access system can be implemented as user mode restriction code 108 in the user space of main memory 110. In some embodiments, the file access system can be implemented, in some combination, both in the user mode and the kernel mode restriction code.

In a preferred embodiment, the file access system is implemented as kernel mode restriction code 104, and additional code is provided in the user mode 108 to provide further protection from any malicious code running in user mode. For example, Anti Code Injection software can be provided to deny an application from controlling another application, whether the application sought to be controlled legally/willingly exposes a remote controlling interface or a COM/DCOM object or if an attacker managed to execute code inside the process. This can provide overall protection and allow the file access system to avoid being bypassed by a malicious code taking over a process and accessing its associated files. It may be difficult or inefficient to detect through the kernel mode malicious code (e.g., a key logger) that runs only in user mode. User mode code can accordingly be used to automatically detect and block such malicious code.

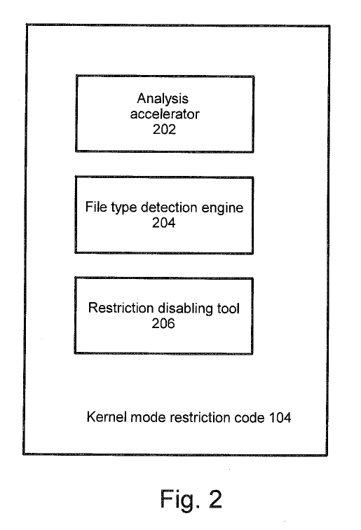

FIG. 2 is a simplified block diagram illustrating components of the kernel mode restriction code 104 in accordance with one or more embodiments of the invention. The kernel mode restriction code 104 includes an analysis accelerator 202 (i.e., a caching engine), a type detection engine 204, and a restriction disabling tool 206. The analysis accelerator or caching engine 202 receives at least some of each file's content and selects information to be used as an identifier or to generate an identifier. As will be described in further detail below, the identifier is stored in cache 114 used to determine whether a file has been previously analyzed and is unchanged. The type detection engine 204 recognizes a file's format, headers, mime type or structure as will be described in further detail below.

Although not shown in the drawings, the file access restriction code shown in FIG. 2 can alternately be implemented in the user mode restriction code.

As used herein, the term “process” refers to the execution of software instructions, including computer applications, software, programs, computer code, subprocesses, threads, or handling procedures that can be run on the computer system. Several processes may be associated with the same computer application, software, program, computer code, or handling procedure. Computer applications, programs and computer code are also stored in the form of files on the computer system and hence will be protected in the same manner by the file restriction system.

As used herein the term “file” refers to any block or arbitrary information, including data or a program, code, or application, stored on the computer system including, but not limited to, all object types that are supported by an “Object Manager” (in kernel) of the Operating System, including objects supported by windows Object Manager (Windows Executive Objects) such as Files, Registry keys, Devices, Drivers, Processes, Threads, Jobs, Sockets, Security, tokens, Memory, sections, LPC ports, I/O completion, WMI, Desktops, Mutexes, Events, Semaphores, I/O Controllers. A file can also include data objects, input or output objects, physical or virtual devices, folders, share, paths, embedded objects, OLE objects, clipboard objects, ACL (Access Control List), object or file attributes, object pointers, handles or file system information or entry, registry objects (e.g., root tree, key, value, ACL, path), pipes, named pipes, device handles or pointers, “DosDevice”, LPC (Local Procedure Call) or RPC (Remote Procedure Call), (port, service, web service), event objects, mailslots, “waitable ports”, symbolic or hard links, URLs, links, shortcuts, physical or direct memory, and raw device access (e.g., network, disk access, RAM, page file). As used herein, a file can also refer to a collection of files.

A process 118 running in the user space 110 of the computer system 102 makes a file access request (e.g., using a path, pointer or handle) through the user mode restriction code 108. The operating system transfers the request from user space 110 to the “real” system functions, which are inside the system core, i.e., kernel space 106. Once the request crosses a “callgate” into the kernel space 106, it can pass through various installed drivers or filters (e.g., filter drivers or mini filter drivers), code modifications, callback functions, hooks, and other types of code. Among the other drivers, filters, or hooks is the kernel mode restriction code 104, which processes the request and can take appropriate action (e.g., denying the request or allowing it). The request is then handled if access is allowed) and then goes all the way back, usually in the same order.

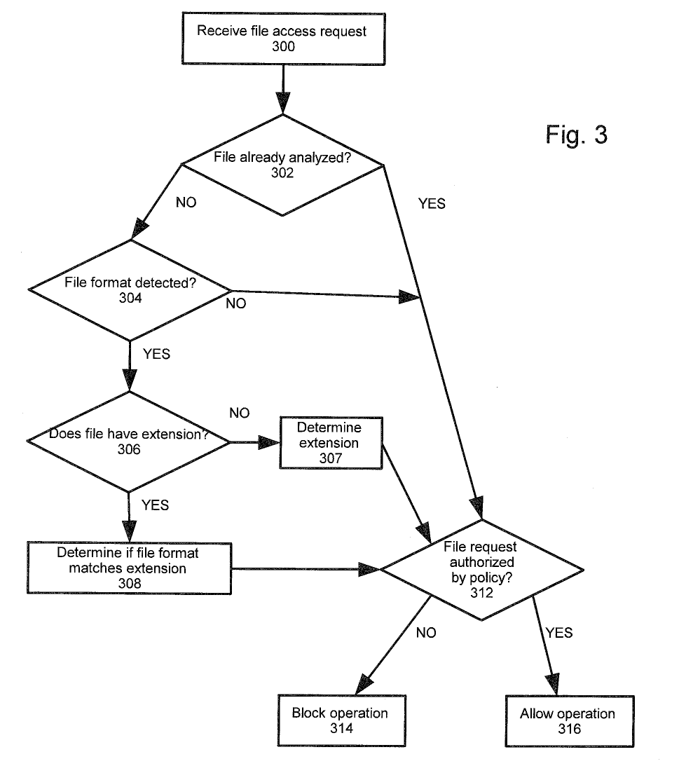

FIG. 3 is a simplified flowchart illustrating an exemplary file access restriction process in accordance with one or more embodiments of the invention. (Although the process is described in FIG. 3 with respect to use of kernel mode restriction code 104, in some embodiments, the process is also applicable with use of user mode restriction code.) At step 300, the kernel mode restriction code 104 receives a file access request from a process 118 running in the user space 110.

At step 302, the kernel mode restriction code 104 determines if the file has already been analyzed and whether the file has been unchanged since a previous analysis. If the file was previously analyzed and has been unchanged, steps 304, 306, and 308 are skipped, and instead the method proceeds directly to step 312. At step 312, a determination is made whether or not to allow the process 118 to access the file in accordance with a given policy as will be further described below.

If at step 302, it is determined that the file has not been previously analyzed or that the file has changed since a previous analysis, the process moves to step 304.

The kernel mode restriction code 104 may include a caching engine 202 or mechanism for rapid storage and retrieval of file contents, configuration or a file identifier (e.g., hash). The identifier (e.g., signature, data modification, mark, flag, application or code) may be modified or added to the file in order to later identify, watch or monitor the object, its duplicates, trails or its usages by any component. The identifier is changed if the file has been changed, and can be used to determine whether the file has been changed at step 302.

At step 304, the content of the file is inspected (using, e.g., the file type detection engine) to determine the actual or real format of the file. For example, the “Mime Type”, “File Type”, “File Format” or identifiable “File Headers” of a file or data object (whether unique or not) are determined by reading the entire file, part of the file, the beginning of the file, or the end of the file in order to find information leading to proof, speculation, or a heuristic of the type or usage of the file to determine the file format of the file. If the file format can be determined, the process continues to step 306.

If at step 304, the file format cannot be determined, the process proceeds to step 312, at which a determination is made whether or not to allow access to the file according to a given security policy. The policy may block the file access operation, as indicated at step 314, or allow the file access operation, as indicated at step 316.

At step 306, the file extension of the file is identified. The file extension can be identified by textual or binary resolving and parsing the name, path, URI, URL, shortcut of the file or object from the end of the string to its beginning finding a DOT character (in ANSI or any other variants of it in any other language, Unicode or any character set), with consideration of filtering left or right trailing characters such as spaces, parsing characters or file system strings (e.g. control characters and NTFS ADS such as “::$DATA”). Advanced file systems such as NTFS (Microsoft NT File System) and HFS (Macintosh Hierarchical file System) are designed in such a way that files and their attributes are objects. This means objects can be pointed to from other objects. For example, when referring to a file called “c:\windows\system32\eula.txt” for read access, under the hood, windows refers to the object “c:\windows\system32\eula.txt” and then refers to its pointer to the general attributes object which links to the data object called “$DATA” and that read action actually gives us “c:\windows\system32\eula.txt::$DATA”. This can cause a mismatch when handling the file extension if the approach is “the file extension is all the chars after the last dot”, which would result the parsed extension to be “txt::$DATA” and differs from txt. The extension may then be accordingly normalized to match what is expected.

If the file does not have an extension, an extension may be determined at step 307, and then the process moves to step 312. For example, the file extension may be determined by reading a stored set of associations 116 from a file association mechanism, e.g., in a system registry, file, storage, device, database or configuration of the machine, system, environment or operating system to retrieve any existing connection, attachment, “handling procedure” or an application object or path associated with the file or object whether by format, name, or path.

If the file does not have an extension and an extension cannot be determined, the process skips to step 312, at which a determination is made whether or not to allow access to the file based on a given security policy, knowing that the file does not have an extension and that the extension cannot be determined.

If the file has a known or associated extension, a determination is made at step 308 as to whether the file format determined at step 304 matches the extension identified at step 306. If there is no match, the process moves to step 312, where appropriate action is taken according to a mismatched extension security policy. For example, the policy may block access to the file if the mismatch is determined. Alternately, the policy may automatically rename the file extension so that it matches the format of the file determined at step 304. The policy may alternately indicate to the user that there is a mismatched extension and request instructions from the user as to whether or not to allow file access.

If at step 308, the file extension is determined to match the file format, the process proceeds to step 312, at which a determination is made whether or not to allow access to the file according to a given security policy. The policy may block the file access operation, as indicated at step 314, or allow the file access operation, as indicated at step 316.

The system for restricting file access automatically creates an initial policy that can later be changed by the system administrator. The initial policy makes use of the file association mechanism to determine which file types will be authorized for access by which applications and processes. For example, the system for restricting file access will create a policy rule that determines that only a Microsoft Word application is allowed to access document files, and will prevent other applications from accessing documents.

The security policy can be set by reading file association information; building a policy in accordance with the file association information comprised of rules that restrict the access of applications to files having based on file type, format, or extension; providing additional rules for the security policy not based on the file association information; and storing the security policy. The security policy can be updated as applications are installed or removed on the computer system.

The system's detection of the real or actual type of files protects the system from being bypassed (e.g., by files imported from another machine with forged extensions). For example, if a file called Hello.ppt is detected as a document in step 304 (and not a presentation, as its file extension would suggest), the application Microsoft PowerPoint, that is handling presentation files by the file association mechanism, will not be authorized to access the file, even though its extension would indicate that Microsoft PowerPoint is the default application to handle it.

Installations of new applications on the computer systems are enabled via a special mechanism that also enables the system to update its policy securely.

As a non-limiting example, a policy utilized in step 312 may limit access to certain files by time or user. For instance, a policy may specify that no one is allowed to read .doc files after 8 p.m., or that no one is allowed to change the extension of a file that has a recognized format.

In accordance with one or more embodiments of the invention, policies can include, but are not limit to, pre-set definitions (e.g., settings, mappings, databases, configurations), an automatic or manual update based configuration or rule set, a user or administrator settings or configurable policy, manual or automatic human or machine based training with or without a graphical user interface, an automated rule set or policy generated or analyzed or determined where these methods are used inside on a local or remote computer(s).

For each configured, chosen or identified object to be restricted, the restriction can include, but is not be limited to: read, write, execute, rename, move, delete, modify, read attributes, change attributes, lock, share, drag, print, change graphical name or icon or any other function, attribute or feature that exists in the file system or the operating system or provided by an third party extension component of any kind. The restriction can be applied to any object, memory segment, pointer, handle, or address space of a process or any other section, data or object determined as related. The restriction may or may not be inherited by child objects, applications, processes, threads or devices. The restriction may or may not be saved as a rule on the local or remote configuration storage and may or may not be limited for a time period or specific identifier whether unique or not. The identifier may be any information chosen to relate to the object, which includes, without limitation to: process name, process id, application's vendor, signature, digital signature, IP, MAC, hardware (e.g. type, information, serial number), volume label, volume serial number, symbolic link, user SID, session, user name, history, origin, name, path, location, hash, index, GUID, title, class name, strings, images, media, attributes, headers, format, extension, streams, mime type, icon, version, size, shape, depth, compression, imports, exports.

In accordance with one or more embodiments, the restriction may be suspended or stopped by the administrator, the protection system itself, or by a special tool 206 supplied to disable one or more restrictions for accessing objects or entities. The special tool to disable restrictions may or may not be used as an export utility to allow safe, controlled, reported or logged exportation of files or data from inside the machine, inside to outside or from an external machine into the local machine. Reports or logs concerning information about file or data objects may be stored locally or transmitted to a network or a remote server of any kind.

The process illustrated in FIG. 3 can be repeated for a plurality of files sought to be accessed by processes in the computer system.

It is to be understood that although the invention has been described above in terms of particular embodiments, the foregoing embodiments are provided as illustrative only, and do not limit or define the scope of the invention. Various other embodiments can also be within the scope of the claims. For example, elements and components described herein may be further divided into additional components or joined together to form fewer components for performing the same functions.

Each computer program within the scope of the claims below may be implemented in any programming language, such as assembly language, machine language, a high-level procedural programming language, or an object-oriented programming language. The programming language may, for example, be a compiled or interpreted programming language.

The techniques described above are preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as an optical disk (for eventual use in a CD or DVD ROM) or floppy disk (for eventual use in a floppy disk drive), a removable storage device (e.g., an external hard drive, memory card, or flash drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

Method claims set forth below having steps that are numbered or designated by letters should not be considered to be necessarily limited to the particular order in which the steps are recited.

What is claimed is:

1. A computer-implemented method of controlling file access in a computer system, comprising:
(a) reading file association information;
(b) building a security policy in accordance with the file association information comprising rules that restrict access of applications to files based on file type, format, or extension;
(c) providing additional rules for the security policy not based on the file association information;
(d) storing the security policy; and
(e) controlling file access in accordance with said security policy.

2. The computer-implemented method of claim 1 wherein step (a) comprises reading the file association information to retrieve any existing connection, attachment, handling procedure or an application object or path associated with the file.

3. The computer-implemented method of claim 1 wherein the file association information is derived from a system registry, file, storage, device, database or configuration of the computer system, environment or operating system.

4. The computer-implemented method of claim 1, wherein step (e) comprises:
(i) receiving a request from a process on the computer system to access a file;
(ii) inspecting the content of the file to determine a file format for the file;
(iii) identifying a file extension of the file;
(iv) determining whether the file format determined in (ii) matches the extension identified in (iii); and
(v) determining whether or not to allow the process to access the file based on the security policy.

5. The computer-implemented method of claim 1, wherein step (e) comprises:
(i) receiving a request from a process on the computer system to access a file;
(ii) inspecting the content of the file to determine a file format for the file; and
(iii) determining whether or not to allow the process to access the file based on the security policy.

6. The computer-implemented method of claim 5 further comprising receiving another request from a process on the computer system to access a file, determining whether the file was previously analyzed to allow file access and is unchanged since the previous analysis, and when the file was previously analyzed and is unchanged since the previous analysis, determining whether or not to allow the process to access to the file based on the given security policy without first performing (ii), and (iii).

7. The computer-implemented method of claim 4 wherein (iii) comprises determining the file extension by textual or binary resolving and parsing the name, path, URI, URL, or shortcut of the file from the end of a string to its beginning, finding a DOT character, and filtering spaces or characters.

8. The computer-implemented method of claim 5 wherein (ii) comprises determining or detecting a “Mime Type”, “File Type”, “File Format” or identifiable “File Headers” of a file by reading at least a portion of the file to find information leading to proof, speculation, or a heuristic of the type or usage of the file.

9. The computer-implemented method of claim 5 further comprising using an identifier for the file in order to determine whether the file was previously analyzed.

10. The computer-implemented method of claim 5 further comprising repeating (i) to (iii) for each of a plurality of files.

11. A computer program product residing on a computer readable medium having a plurality of instructions stored thereon which, when executed by a processor, cause that processor to:
(a) read file association information;
(b) build a security policy in accordance with the file association information comprising rules that restrict access of applications to files based on file type, format, or extension;
(c) provide additional rules for the security policy not based on the file association information;
(d) store the security policy; and
(e) control file access in accordance with said security policy.

12. The computer program product of claim 11 wherein step (a) comprises reading the file association information to retrieve any existing connection, attachment, handling procedure or an application object or path associated with the file.

13. The computer program product of claim 11 wherein the file association information comprises a system registry, file, storage, device, database or configuration of the computer system, environment or operating system.

14. The computer program product of claim 11 wherein (e) further comprises instructions that cause the processor to:
(i) receive a request from a process on the computer system to access a file;
(ii) inspect the content of the file to determine a file format for the file;
(iii) identify a file extension of the file;
(iv) determine whether the file format determined in (ii) matches the extension identified in (iii); and
(v) determine whether or not to allow the process to access the file based on the security policy.

15. The computer program product of claim 11 wherein (e) further comprises instructions that cause the processor to:
(i) receive a request from a process on the computer system to access a file;
(ii) inspect the content of the file to determine a file format for the file;
(iii) determine whether or not to allow the process to access the file based on the security policy.

16. The computer program product of claim 15 further comprising instructions that cause the processor to receive another request from a process on the computer system to access a file, determine whether the file was previously analyzed to allow file access and is unchanged since the previous analysis, and when the file was previously analyzed and is unchanged since the previous analysis, determine whether or not to allow the process to access to the file based on the given security policy without first performing (ii) and (iii).

17. The computer program product of claim 14 wherein (iii) comprises determining the file extension by textual or binary resolving and parsing the name, path, URI, URL, or shortcut of the file from the end of a string to its beginning, finding a DOT character, and filtering spaces or characters.

18. The computer program product of claim 15 wherein (ii) comprises determining or detecting a “Mime Type”, “File Type”, “File Format” or identifiable “File Headers” of a file by reading at least a portion of the file to find information leading to proof, speculation, or a heuristic of the type or usage of the file.

19. The computer program product of claim 15 wherein further comprising using an identifier for the file in order to determine whether the file was previously analyzed.

20. The computer program product of claim 15 wherein further comprising repeating (i) to (iii) for each of a plurality of files.
